(19) United States
(12) Patent Application Publication
(10) Pub. No.: US 2026/0031466 A1
(43) Pub. Date: Jan. 29, 2026

(54) BATTERY MODULE AND CELL SEPARATING ELEMENT WITH COOLING FUNCTION

(71) Applicant: AUDI AG, lngolstadt (DE)

(72) Inventors: Onur EMRE, Nürnberg (DE); Carsten LORENZ, Reichertshofen (DE); Eduard MAIN, Buxheim (DE)

(73) Assignee: AUDI AG, lngolstadt (DE)

(21) Appl. No.: 19/277,597

(22) Filed: Jul. 23, 2025

(30) Foreign Application Priority Data
Jul. 26, 2024 (DE) 102024121406.6

(51) Int. Cl. H01M 50/293; H01M 10/613; H01M 10/625; H01M 10/6557; H01M 10/6567; H01M 10/658; H01M 50/209; H01M 50/242; H01M 50/249

(52) U.S. Cl. CPC H01M 50/293; H01M 10/613; H01M 10/625; H01M 10/6557; H01M 10/6567; H01M 10/658; H01M 50/242; H01M 50/209; H01M 50/249

(57) ABSTRACT

A cell separating element for arrangement between two battery cells, which includes an outer wall which encloses an interior space and which provides a first outer wall and an opposite second outer wall, a first cooling region located in the interior space, which adjoins the first outer wall and which includes a first cooling channel, and a second cooling region located in the interior space, which adjoins the second outer wall and which includes a second cooling channel. The cell separating element includes a compression layer made of an elastically deformable material arranged in the interior space. The compression layer is arranged between the first and second cooling regions with respect to the first direction.

### FIELD

The invention relates to a cell separating element for arrangement between two battery cells of a cell stack, wherein the cell separating element comprises an outer wall which encloses an interior space of the cell separating element and which provides a first outer wall and a second outer wall located opposite with respect to a first direction. In addition, the cell separating element comprises a first cooling region located in the interior space, which adjoins the first outer wall and which comprises at least one first cooling channel through which a coolant can flow, and a second cooling region located in the interior, which adjoins the second outer wall and which comprises at least one second cooling channel through which a coolant can flow. Furthermore, the invention also relates to a battery module with such a cell separating element.

### BACKGROUND

Today's cooling systems for batteries, in particular high-voltage batteries for motor vehicles, often only use a relatively small area of the battery cells for cooling, in that the cooling systems are positioned below and/or above the cells or cell stacks. In addition, battery cells, for example lithium-ion cells, show strong swelling behavior over their lifetime, particularly due to aging and the charging and discharging of the battery cells. For this purpose, materials which can absorb the swelling behavior by being compressed are used in the module or in the cell stack, which can also be referred to as the cell pack, or in the overall system between the cells. Such materials may be provided in the form of cell separating elements positioned between the battery cells. Cell separating elements by means of which a cooling function can be provided are also known from the prior art.

For example, DE 10 2022 100 744 A1 describes a cooling element with a plurality of elastic tube elements which are arranged extending in a plane, wherein a fluid can flow through the tube elements which are spaced apart from one another, and wherein a compressible material is provided between the tube elements. Such a cooling element can be provided for arrangement between two adjacent battery cells of a stack arrangement.

FR 3 135 566 A1 describes an electricity storage device with battery cells arranged side by side and separated from one another by a gap, wherein a separating structure is provided in each gap which delimits at least one circulation channel of a heat transfer fluid which is in contact with the largest surfaces of the adjacent battery cells, wherein the separating structure is a compressible sandwich comprising two metal plates between which a compressible material is located.

DE 10 2018 214 529 A1 describes an accumulator arrangement with multiple battery cells that are stacked in the stacking direction to form a battery block, and with a cooling device that comprises multiple cooling elements through which a cooling fluid can flow, which are arranged between the adjacent battery cells and clamped to them in the stacking direction. In this case, a respective cooling element has or is formed by a compressible, porous intermediate insert with multiple pores through which the cooling fluid can flow, wherein the intermediate insert is arranged between the respective adjacent battery cells and is connected to them in a heat-transferring manner.

Furthermore, DE 10 2020 118 002 A1 describes a battery module with multiple battery cells between which deformable foam plates are arranged to compensate for deformations of the battery cells. A cooling medium for cooling the battery cells can also be passed between any two adjacent battery cells. The cooling medium is a cooling liquid that comes into direct contact with the battery cells, wherein a cooling structure for conducting the cooling liquid to the battery cell and along the same is arranged between the respective battery cell and the foam plate facing it.

However, the integration of cooling functions into cell separating elements is associated with problems: If the cell separating elements are designed as rigid cooling plates, for example, they cannot compensate for the cell swelling described above. This leads to premature aging of the battery cells if no compensation for swelling is provided. If the heat sink is too soft, there is a risk that it will be compressed by the swelling forces and no more cooling medium can flow, which means a reduction or loss of cooling performance. A multi-layered structure of the cell separating element also requires a relatively large amount of installation space between the battery cells.

### SUMMARY

It is therefore the object of the present invention to provide a cell separating element and a battery module which allow the integration of a cooling function which is as reliable as possible into a cell separating element without having to forego a specific swelling compensation. In particular, it is the object of advantageous further developments of the invention to make this possible in a particularly space-saving manner.

A cell separating element according to the invention for arrangement between two battery cells of a cell stack comprises an outer wall which encloses an interior space of the cell separating element and which provides a first outer wall and a second outer wall located opposite with respect to a first direction, a first cooling region located in the interior space, which cooling region adjoins the first outer wall and comprises at least one first cooling channel through which a coolant can flow, and a second cooling region located in the interior space, which cooling region adjoins the second outer wall and comprises at least one second cooling channel through which a coolant can flow. In addition, the cell separating element comprises a compression layer made of an elastically deformable material arranged in the interior space, wherein the compression layer is arranged between the first and second cooling regions with respect to the first direction, and wherein a first compressibility associated with the compression layer is greater, at least with respect to the first direction, than a respective second compressibility associated with the first and second cooling regions.

Since the compressibility associated with the compression layer is greater than that of the first and second cooling regions, i.e., since the compression layer can be compressed more easily than the first and second cooling regions, swelling compensation can be provided by compressing the compression layer without significantly compressing the cooling regions. This ensures that the cooling function can be reliably ensured even if the battery cells swell and the cell separating element is compressed. Due to the compressibility of the compression layer, the cell separating element as a whole can be compressed with respect to the first direction, which can absorb cell swelling, which in turn has a positive effect on the service life of the battery cells. This means that a cooling function and swelling compensation can be integrated into a cell separating element without impairing the cooling function.

With respect to a proper installation position of the cell separating element in a cell stack between two battery cells of the cell stack, the first direction corresponds to a stacking direction in which the battery cells of the cell stack are next to each other. The battery cells in the cell stack are preferably arranged with their largest surface areas facing each other. The battery cells can be prismatic battery cells or pouch cells, for example. Accordingly, it is very advantageous if the outer walls provided by the outer wall are flat. This allows them to lie flat against the largest cell sides of the adjacent battery cells in terms of their intended installation position in the cell stack. This allows for particularly efficient heat dissipation from the battery cells to the cell separating element, and also allows particularly even force distribution across the cell sides of the battery cells during cell swelling.

The compressibility associated with the compression layer and the respective cooling regions can be defined as a distance by which the compression layer or the cooling regions are reduced relative to an initial state under normal or standard conditions at a specific pressure application with respect to the first direction, for example. The initial state or reference state, respectively, can be defined for normal conditions or standard conditions. These can be defined as an ambient pressure of 1013.25 mbar and a temperature of 20° C.

Since the compressibility of the compression layer is greater than that of the cooling areas, the compression layer has a compression modulus that is smaller than that of the cooling areas. For example, the compression layer is softer and/or more flexible than the respective cooling areas. In particular, these can be incompressible in the first direction up to a specific minimum pressure, which can act as a maximum on the cell separating element, for example in a cell stack or battery module.

The compressibility of the compression layer can also vary locally. In this case, each compressibility of each region of the compression layer should be greater than the maximum compressibility of the respective cooling regions.

The cooling areas can be provided by relatively rigid cooling structures, for example. It is particularly advantageous if these cooling structures are made of metal, since this enables particularly good heat conduction on the one hand, and on the other hand allows a particularly thin-walled design of the cooling structures while at the same time making the cooling structures as rigid as possible. Accordingly, it is also preferred that at least the two outer walls or the outer wall as a whole are made of a metal, for example aluminum. The compression layer or the compressible metal of the compression layer may comprise a foam, for example, in particular a plastic foam. The material may also include other components, for example fillers integrated into such a foam. The material can thus be designed as filled foam, for example. Furthermore, the material can be homogeneous or have homogeneous material properties, such as hardness or strength, or can be formed with locally different properties. For example, the compression layer can be designed to be more compressible or softer in a central region with respect to a second and/or third direction perpendicular to the first direction than edge regions of the compression layer that are further outward with respect to the second and/or third direction.

Preferably, the cell separating element is used to cool the adjacent battery cells without the coolant, which is preferably a cooling liquid, flowing through the cell separating element coming into direct contact with the battery cells. Accordingly, it is preferred that the outer wall is designed to be fluid-tight, i.e., for example, it has no holes or the like.

According to another advantageous embodiment of the invention, the compression layer runs in a wave-shaped or zigzag-shaped manner in a second direction perpendicular to the first direction. Such a wave-shaped or serpentine or zigzag-shaped course allows a particularly space-saving design of the cooling areas and accordingly of the cell separating element as a whole, in particular with respect to its extension in the first direction. Such a wave-shaped or zigzag-shaped course can also simultaneously define the geometry of the cooling channels of the adjacent cooling areas. The cooling channels can be offset from each other in the second direction, so to speak. At the location where the at least one first cooling channel has a maximum dimension with respect to the first direction, for example, no cooling channel can be arranged in the corresponding second cooling region, or the at least one second cooling channel arranged in the second cooling region can have a significantly smaller dimension or minimum dimension with respect to the first direction, and vice versa.

It is therefore another advantageous embodiment of the invention if the at least one first and second cooling channels run in a third direction perpendicular to the first and second directions and are offset from one another with respect to the second direction. In particular, the at least one first and the at least one second cooling channel can run parallel to each other in the third direction. However, these are located at different heights with respect to the second direction. When the cell separating element is compressed in the first direction, the cooling channels can partially overlap in the second direction or mesh without collision. This allows making the cell separating element significantly thinner in the first direction.

Another great advantage of the wave-shaped or zigzag-shaped course of the compression layer is that it can nevertheless be designed with a substantially constant thickness in the first direction, as is provided according to another advantageous embodiment of the invention. Accordingly, the compression layer has a thickness defined in the first direction, for example relative to the initial state or reference state described above, which thickness is constant. Under specific circumstances, specific regions of the cell separating element may be compressed more than others during use in a cell stack, which may result in that the thickness of the compression layer is smaller in a central region of the cell separating element than in corresponding edge regions, for example.

The compression layer can also simultaneously provide a thermal barrier between the two cooling regions, which is particularly advantageous in the range of thermal runaway of a battery cell. By designing the compression layer with a substantially constant thickness, a particularly uniform thermal barrier can be provided.

The first and second cooling regions can each also comprise multiple cooling channels. For example, these can all run parallel in the third direction. The first cooling channels can then be arranged at an offset relative to the second cooling channels with respect to the second direction, as already described with respect to the at least one first cooling channel and the at least one second cooling channel.

According to another advantageous embodiment of the invention, the cell separating element comprises a first and a second boundary wall arranged in the interior space, between which boundary walls the compression layer is arranged adjacent to the first and second boundary wall, wherein the first boundary wall adjoins the first cooling channel and the second boundary wall adjoins the second cooling channel, in particular wherein the first boundary wall contacts the first outer wall at first some contact points and the second boundary wall contacts the second outer wall at some second contact points. According to one embodiment, these boundary walls can also be formed integrally with the outer walls.

The compression layer is therefore arranged adjacent to the boundary walls and between these boundary walls. The compression layer can completely fill the space between these boundary walls. It is also conceivable that the compression layer can be divided into individual and spatially separated compression regions, each of which is arranged adjacent to the first and second boundary walls, and between which there is a cavity, for example. However, it is particularly advantageous if the compression layer or the compressible material, respectively, almost completely or completely fills the space between the boundary walls since this enables particularly uniform pressure absorption and pressure distribution.

The fact that the respective boundary walls contact the outer walls at the respective contact points can be easily achieved, for example, by having the boundary walls run in a wave-like or zigzag shape in the second direction. The wave crests of the wave-shaped course or the peaks of the zigzag-shaped course facing the relevant outer walls can then contact, that is, touch, the associated outer wall, but not other regions of the boundary walls. The contact points can accordingly run in the third direction in a linear manner, in particular in a straight line, and in particular parallel to one another. The contact points then separate the cooling channels of the same cooling region, which are arranged next to each other in the second direction, apart from each other. The contact points allow the cooling region to be divided into several individual cooling channels. The boundary walls can, for example, be corrugated, for example as corrugated iron. The wavelength of the wave-like or zigzag pattern can be constant or likewise vary in the second direction. This makes it possible, for example, to provide cooling channels with different widths in the second direction. Since the respective boundary walls contact the corresponding outer walls in some places, support points are provided by means of which the boundary wall is supported against the associated outer wall. This prevents compression of the cooling channels located between these walls, namely a respective boundary wall and the associated outer wall.

The boundary walls are also preferably made of a metallic material, for example aluminum.

According to another advantageous embodiment of the invention, the first cooling region is provided by a first cooling plate which comprises the first outer wall and the first boundary wall, the second cooling region is provided by a second cooling plate which comprises the second outer wall and the second boundary wall, wherein the two cooling plates are joined to one another in their edge regions opposite one another with respect to the second direction. For example, they can be glued or welded together at their edges or the like. The cooling plates are particularly shaped such that there is a gap between the two boundary walls, in which gap the compression layer is located. To produce such a cell separating element, the compression layer can for example be provided as a separate component, for example as a foam mat, which is inserted or glued between the two cooling plates, whereby the two cooling plates are then joined together. Alternatively, the two cooling plates can first be joined together and the remaining space between them filled with the foam material to create the compression layer.

This design allows a particularly simple and advantageous production of the cell separating element. However, there are also other advantageous manufacturing options, which are explained in more detail below.

According to another advantageous embodiment of the invention, the compression layer and the first and second boundary walls are joined together to form a sandwich structure, and the sandwich structure is arranged, in particular inserted, in a housing that provides the outer wall. The housing can be provided in one piece or in several parts, for example by two shells which are joined together in an edge region, opposite one another with respect to the second direction. According to this variant, the sandwich structure can first be manufactured by arranging the compression layer between the two boundary walls, for example. The individual layers, i.e., the two boundary walls and the compression layer, can adhere to each other, for example due to manufacturing or by means of adhesive. This finished sandwich structure can then be inserted between the two shell halves that provide the housing, which are then joined together. Due to the wave-shaped structure or zigzag-shaped structure of the boundary sides, the sandwich structure can position itself in the interior space by inserting it into the interior space, forming the respective first and second cooling channels, without having to be fixed by means of a material bond or in any other way.

According to another advantageous embodiment of the invention, the outer wall and the boundary walls are formed in one piece, in particular as an extruded profile. The space between the boundary walls can easily be filled with the foam material to form the compression layer. This also allows for particularly simple and efficient production, which requires very few individual components. Separate joining steps can therefore be eliminated.

According to another advantageous embodiment of the invention, the cell separating element comprises a coolant supply port and a coolant discharge port, which are arranged in end regions of the cell separating element and that are opposite one another with respect to the third direction. These ports can be designed as separate components and attached to the outer wall, in particular to the end faces of the outer wall opposite one another with respect to the third direction, or these ports can themselves be designed as parts of the wall or be formed therefrom. A coolant can therefore advantageously be supplied to the cell separating element, in particular to the interior space, via the coolant supply port, which coolant can be discharged from the cell separating element again via the coolant discharge port after passing through the interior or the at least one first and second cooling channels.

In a less preferred embodiment, the cell separating element can also be designed without coolant port and as such can be positioned in a space between two battery cells. The coolant can then flow through the receiving space in which the cell stack is located as a whole or at least a part thereof. This coolant can then also flow through the cell separating elements located between the battery cells through their respective cooling channels.

Furthermore, the invention also relates to a battery module having a cell separating element according to the invention or of one of its embodiments. The battery module can comprise the cell stack with at least two battery cells between which the cell separating element is arranged. Such a cell stack can also comprise substantially more than two battery cells, wherein a separating element according to the invention or one of its embodiments can be arranged between each two battery cells arranged next to one another in the stacking direction. The battery module can therefore also comprise multiple such cell separating elements.

Furthermore, the battery module or the cell stack can be designed as already explained in connection with the cell separating element according to the invention and its embodiments.

Furthermore, the invention also relates to a battery, in particular a high-voltage battery having a battery module according to the invention or one of its embodiments.

Furthermore, the invention also relates to a motor vehicle having a battery according to the invention or one of its embodiments.

The motor vehicle according to the invention is preferably designed as an automobile, in particular as a passenger car or truck, or as a passenger bus or motorcycle.

The invention also includes further developments of the battery module according to the invention and the battery according to the invention, which have features as already described in connection with the further developments of the cell separating element according to the invention.

For this reason, the respective further developments of the battery module according to the invention and of the battery according to the invention are not described again here.

The invention may also include manufacturing methods for producing a cell separating element according to the invention or one of its embodiments, as have been described in connection with the descriptions of the cell separating element and its embodiments, for example.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic representation of a battery module with two battery cells and a cell separating element arranged in an uncompressed initial state according to an exemplary embodiment of the invention;

FIG. 2 shows a schematic representation of the battery module of FIG. 1 with the cell separating element in a compressed state according to an exemplary embodiment of the invention;

FIG. 3 shows a schematic representation of a cell separating element according to another exemplary embodiment of the invention;

FIG. 4 shows a schematic representation of a part of a battery module according to another exemplary embodiment of the invention; and

FIG. 5 shows a schematic representation of a cell separating element in a top plan view according to another exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

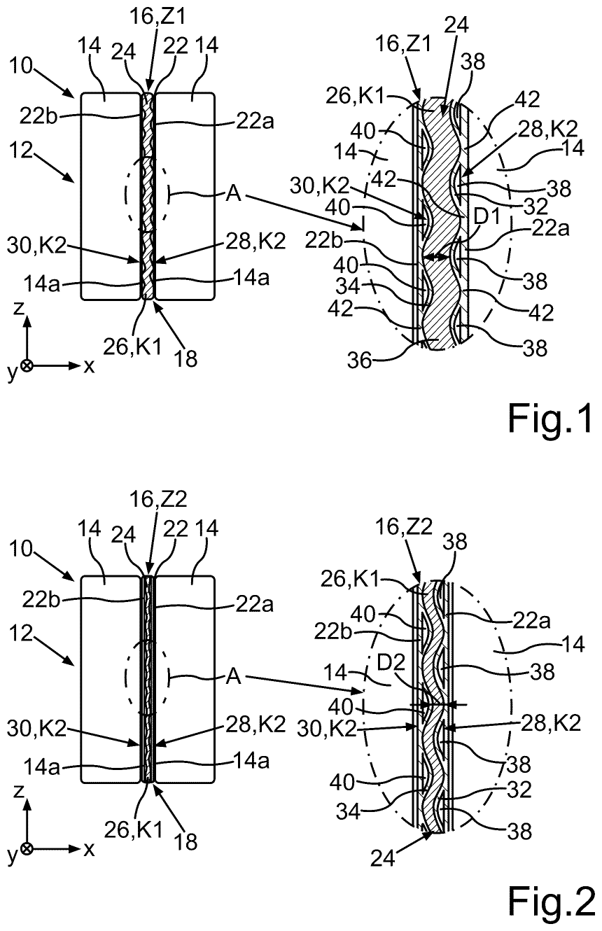

FIG. 1 shows a schematic representation of a battery module 10 with a cell stack 12 and a cell separating element 16 arranged between two battery cells 14 of the cell stack 12 in an uncompressed state Z1 according to an exemplary embodiment of the invention; and A cutout A of the battery module 10 in the area of the cell separating element 16 is shown again enlarged in FIG. 1. The battery module 10 or the cell separating element 16 is shown in particular in a side view without the coolant supply or discharge ports 20 shown (see FIG. 5) or in a cross-sectional view perpendicular to the y-axis shown. Two battery cells 14 of the cell stack 12 are shown as examples, wherein the cell stack 12 can also comprise more than two battery cells 14. The battery cells 14 are arranged next to one another in a flow x which corresponds to the aforementioned first direction when the cell separating element 16 is arranged as intended between two battery cells 14, as shown here. The cell separating element 16 can extend in the x and/or y and/or z direction over the entire intermediate space 18 or almost the entire intermediate space 18. The optional ports 20 (see FIG. 5) of the cell separating element 16 can protrude from this intermediate space 18 in and against the y-direction, for example.

The cell separating element 16 now comprises an outer wall 22, which in turn provides a first outer wall 22a and a second outer wall 22b, which are located opposite each other in the x-direction. The respective outer walls 22a, 22b can be designed to be flat and can adjoin the adjacent cell sides 14a of the battery cells 14, in particular lie flat against them. The outer wall 22 surrounds or encloses an interior space 24 of the cell separating element 16. The cell separating element 16 also comprises a compression layer 26 arranged in the interior space 24 as well as a first cooling region 28 and a second cooling region 30. The compression layer 26 is arranged between the two cooling regions 28, 30 with respect to the x-direction. The compression layer 26 has a first compressibility K1 which is greater than a compressibility K2 assigned to the cooling regions 28, 30, at least with respect to the x-direction.

The cell separating element 16 also comprises a first boundary wall 32 and a second boundary wall 34, which adjoin the compression layer 26 on both sides. In particular, the compression layer 26 can fill the intermediate space 36 between the two boundary walls 32, 34 at least partially or completely, like in this example. The first cooling region 28 may comprise the first outer wall 22a, the first boundary wall 32, and first cooling channels 38 arranged between these walls 22a, 32 and delimited by the walls 22a, 32. Accordingly, the second cooling region 30 may comprise the second outer wall 22b, the second boundary wall 34 and the second cooling channels 40 located between these walls 22b, 34 and delimited by them.

The compression layer 26 is wavy with respect to the z-direction. This can easily be achieved by having the boundary walls 32, 34 have a wave-like configuration. Each of these boundary walls 32, 34 contacts a respective outer wall 22a, 22b at respective contact points 42 or contact regions. The outer wall 22 and the boundary walls 32, 34 may be formed from a metallic material, for example aluminum or steel. In this example, the outer wall 22 and the boundary walls 32, 34 are made in one piece, e.g. as an extruded profile. The wave-shaped course of the compression layer 26 allows a particularly space-saving arrangement to be provided, since the first cooling channels 38 can thus also be arranged at an offset from the second cooling channels 40 with respect to the z-direction.

The compression layer 26 may, for example, be formed from a foam material, for example a plastic foam or the like. The outer wall 22 can provide a metallic outer skin in which the cooling channels 38, 40 are integrated. Due to the greater compressibility K1 of the compression layer 26, it can be achieved that the geometry and cross-section of the channels 38, 40 are not changed, or at least not significantly changed, during the swelling process of the battery cells 14. Between the outer regions, namely the cooling regions 28, 30, a material is inserted from which the compression layer 26 is formed, which material can be compressed. This can also be referred to as the core. This can be a homogeneous material, in particular a foam, for example a PU (polyurethane) foam, an EPDM (ethylene propylene diene monomer) foam, or another technical foam. Thus, when in operation, the cooling medium can only flow through the cooling channels 38, 40 and not through the foam core provided by the compression layer 26. During swelling, i.e., swelling of the cells 14, the foam core 26 of this heat sink provided by the cell separating element 16 can be deformed and follow the changing cell geometry over the lifetime, in particular reversibly for swelling paths that correspond to a state of charge of the cells 14 from 0% to 100% SOC (State of Charge) and/or irreversibly for swelling paths over the lifetime.

FIG. 2 shows once again a schematic representation of the battery module 10 from FIG. 1, wherein the cell separating element 16 is now in a compressed state Z2, which can be caused by such cell swelling. The thickness D1 of the compression layer 26, which is preferably constant at least in the initial state Z1, can be correspondingly smaller in the compressed state Z2 of the cell separating element 16, wherein this smaller thickness is designated D2. As can be seen in FIG. 2, only the compression layer 26 compresses, and the respective cross sections of the cooling channels 38, 40 remain unchanged in terms of geometry and area.

The compression layer 26 may also have locally different foam densities. By using different foam densities, the strength of the system can be adapted to the swelling requirements between the cell center and cell edge in relation to the y- and/or z-directions shown. A complete compression of the heat sink, i.e., the cell separating element 16, is not possible because the cooling channels 38, 40 can be supported on the respective opposite side. The stiffness of the channels 38, 40 is also preferably higher than the swelling force of the cells, in particular such that the channels 38, 40 or the walls 22a and 32 or 22b and 34 delimiting the channels 38, 40 withstand the swelling force of the cells 14. Preferably, the channels 38, 40 are arranged at an offset as described so that a maximally compact component with the greatest possible swelling path can be implemented.

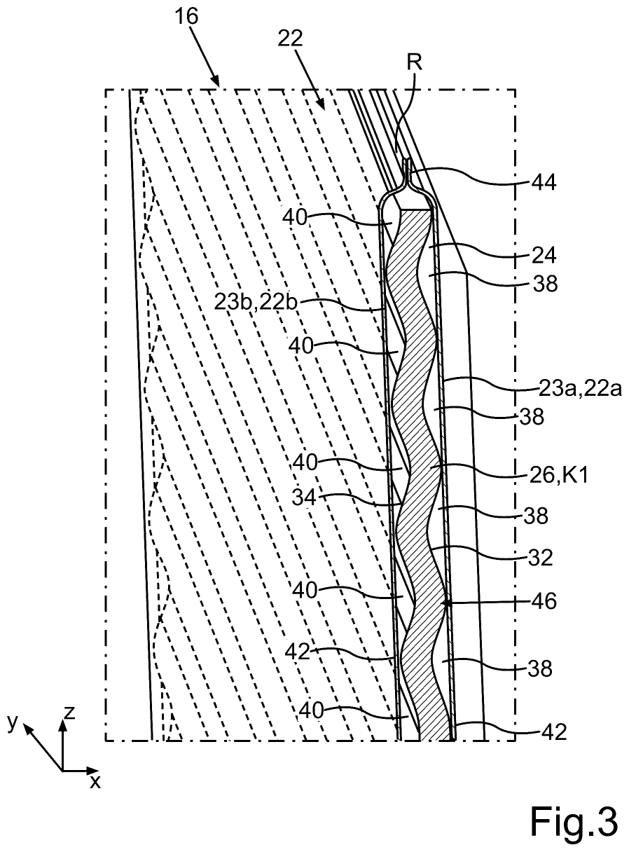

FIG. 3 shows a schematic and perspective cross-sectional representation of a cell separating element 16 according to another exemplary embodiment of the invention. It can be designed as described above, except for the differences described below. In this case, the outer wall 22 is formed by two shell halves 23a, 23b which are connected to one another in two edge regions R opposite one another with respect to the z-direction, of which only one is visible in the present case, by a joining connection, for example by gluing and/or welding. A joint connection is denoted by 44. Each of these shells 23a, 23b provides one of the outer walls 22a, 22b. The boundary walls 32, 34 together with the compression layer 26 form a sandwich component 46 which is arranged in the interior space 24 of the cell separating element 16. The sandwich component 46 can simply be inserted into the interior space 24, for example. In this case, the outer walls 22a, 22b and the two boundary walls 32, 34 are not formed as a single piece as an extruded profile, but are designed as separate components.

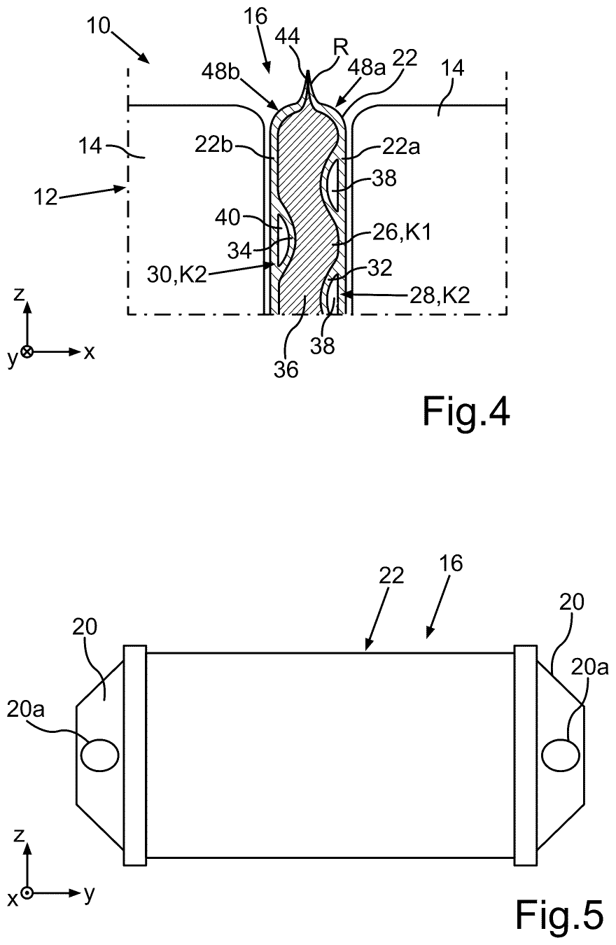

FIG. 4 shows a schematic representation of a part of a battery module 10 with a cell separating element 16 according to another exemplary embodiment of the invention. It can be designed as described above with respect to FIG. 1 and FIG. 2, except for the differences described below. In this example, the respective cooling regions 28, 30 are provided by two cooling plates 48a, 48b. The two cooling plates can be joined together via a joint connection 44 in an edge region R or in two edge regions R opposite each other with respect to the z-direction, of which only one is shown. Each of these cooling plates 48a, 48b comprises one of the outer walls 22a, 22b, as well as one of the boundary walls 32, 34. The walls 22a, 32 and 22b, 34 of a respective cooling plate 48a, 48b can also be formed in one piece, for example, as extruded profiles or manufactured by means of a roll-bonding process or the like. In this case, the cooling plates 48a, 48b can first be provided as separate components and then connected to one another via the joint connection 44, for example. Before joining, the compression layer 26 can be inserted between the plates 48a, 48b as a finished foam layer or glued to one of the two boundary sides 32, 34, or the compression layer 26 can also be injected into the intermediate space 36 in viscous foam form after the two plates 48a, 48b have been joined, and then solidify or harden.

FIG. 5 shows a schematic representation of a cell separating element 16 in a top view of the x-direction. In this case, the cell separating element 16 also comprises interfaces 20 for the coolant supply, namely a coolant supply port 20 and a coolant discharge port. These ports 20 are arranged on both sides of the outer wall 22 of the cell separating element 16 with respect to the y-direction. The interfaces 20 can each be designed in the form of an overmolded frame or as lateral water boxes. They can be designed with nozzles 20a or similar ports, for example to connect a coolant line to introduce the coolant into the cell separating element 16 and to discharge it therefrom. Alternatively, the cell package, i.e. the cell stack 12 including the intercell cooler provided by the cell separating element 16, can be located directly in the coolant and, due to the pressure difference between the flow and return lines, the coolant flows between the cells 14 through the cooling plates or cooling regions 28, 30 of the cell separating element 16. In this case, the ports 20 can be eliminated.

Overall, the examples show how the invention can provide an intercell cooler with swelling compensation. For better cooling of in particular prismatic cells in a cell stack, cooling can be installed between the cells, which is provided by the cell separating element described above. The heat sink can be designed such that the cooling and swelling functions can be implemented in one component. This allows effective, direct cooling with a constant cooling channel cross-section, taking into account swelling compensation, from the beginning of the battery module's service life to the end of its service life. The cell separating element described enables a very high level of functional integration and a reduction in the complexity of a high-voltage battery by combining the functions of intermediate cell separating elements for swelling compensation and battery cooling. This enables an increase in cooling performance by increasing the connected cooling surface. In addition, this also enables cost reduction by eliminating the need for expensive thermal pastes for thermal connection to the cells and cost reduction by eliminating the need for insulation material between the cells to prevent thermal propagation, since this functionality can also be assumed by the compression layer.

1. A cell separating element for arrangement between two battery cells of a cell stack, comprising:
an outer wall which encloses an interior space of the cell separating element and which provides a first outer wall and a second outer wall located opposite with respect to a first direction,
a first cooling region located in the interior space, which cooling region adjoins the first outer wall and which comprises at least one first cooling channel through which a coolant can flow, and
a second cooling region located in the interior space, which cooling region adjoins the second outer wall and which comprises at least one second cooling channel through which a coolant can flow,
wherein the cell separating element comprises a compression layer made of an elastically deformable material arranged in the interior space, wherein the compression layer is arranged between the first and second cooling regions with respect to the first direction, and wherein a first compressibility associated with the compression layer is greater than a respective second compressibility associated with the first and second cooling regions, at least with respect to the first direction.

2. The cell separating element according to claim 1, wherein the compression layer extends in a wave-like or zigzag-like manner in a second direction perpendicular to the first direction.

3. The cell separating element according to claim 1, wherein the compression layer has a thickness defined in the first direction, which is constant in the uncompressed state of the cell separating element.

4. The cell separating element according to claim 1, wherein the at least one first and second cooling channels extend in a third direction perpendicular to the first and second directions and are offset from one another in their arrangement with respect to the second direction.

5. The cell separating element according to claim 1, wherein the cell separating element comprises a first and a second boundary wall arranged in the interior space, between which the compression layer is arranged adjacent to the first and second boundary walls, wherein the first boundary wall adjoins the first cooling channel and the second boundary wall adjoins the second cooling channel, in particular wherein the first boundary wall contacts the first outer wall at some first contact points and the second boundary wall contacts the second outer wall at some second contact points.

6. The cell separating element according to claim 1, wherein the first cooling region is provided by a first cooling plate comprising the first outer wall and the first boundary wall,
the second cooling region is provided by a second cooling plate comprising the second outer wall and the second boundary wall,
wherein the two cooling plates are joined together in their edge regions opposite one another with respect to the second direction.

7. The cell separating element according to claim 1, wherein the compression layer and the first and second boundary walls are joined together to form a sandwich structure, and the sandwich structure is arranged, in particular inserted, in a housing providing the outer wall.

8. The cell separating element according to claim 1, wherein the outer wall and the boundary walls are formed in one piece, in particular as an extruded profile.

9. The cell separating element according to claim 1, wherein the cell separating element comprises a coolant supply port and a coolant discharge port which are arranged in end regions of the cell separating element opposite one another with respect to the third direction.

10. A battery module with a cell separating element according to claim 1.

11. The cell separating element according to claim 2, wherein the compression layer has a thickness defined in the first direction, which is constant in the uncompressed state of the cell separating element.

12. The cell separating element according to claim 2, wherein the at least one first and second cooling channels extend in a third direction perpendicular to the first and second directions and are offset from one another in their arrangement with respect to the second direction.

13. The cell separating element according to claim 3, wherein the at least one first and second cooling channels extend in a third direction perpendicular to the first and second directions and are offset from one another in their arrangement with respect to the second direction.

14. The cell separating element according to claim 2, wherein the cell separating element comprises a first and a second boundary wall arranged in the interior space, between which the compression layer is arranged adjacent to the first and second boundary walls, wherein the first boundary wall adjoins the first cooling channel and the second boundary wall adjoins the second cooling channel, in particular wherein the first boundary wall contacts the first outer wall at some first contact points and the second boundary wall contacts the second outer wall at some second contact points.

15. The cell separating element according to claim 3, wherein the cell separating element comprises a first and a second boundary wall arranged in the interior space, between which the compression layer is arranged adjacent to the first and second boundary walls, wherein the first boundary wall adjoins the first cooling channel and the second boundary wall adjoins the second cooling channel, in particular wherein the first boundary wall contacts the first outer wall at some first contact points and the second boundary wall contacts the second outer wall at some second contact points.

16. The cell separating element according to claim 4, wherein the cell separating element comprises a first and a second boundary wall arranged in the interior space, between which the compression layer is arranged adjacent to the first and second boundary walls, wherein the first boundary wall adjoins the first cooling channel and the second boundary wall adjoins the second cooling channel, in particular wherein the first boundary wall contacts the first outer wall at some first contact points and the second boundary wall contacts the second outer wall at some second contact points.

17. The cell separating element according to claim 2, wherein the first cooling region is provided by a first cooling plate comprising the first outer wall and the first boundary wall,
the second cooling region is provided by a second cooling plate comprising the second outer wall and the second boundary wall,
wherein the two cooling plates are joined together in their edge regions opposite one another with respect to the second direction.

18. The cell separating element according to claim 3, wherein the first cooling region is provided by a first cooling plate comprising the first outer wall and the first boundary wall,
the second cooling region is provided by a second cooling plate comprising the second outer wall and the second boundary wall,
wherein the two cooling plates are joined together in their edge regions opposite one another with respect to the second direction.

19. The cell separating element according to claim 4, wherein the first cooling region is provided by a first cooling plate comprising the first outer wall and the first boundary wall,
the second cooling region is provided by a second cooling plate comprising the second outer wall and the second boundary wall,
wherein the two cooling plates are joined together in their edge regions opposite one another with respect to the second direction.

20. The cell separating element according to claim 5, wherein the first cooling region is provided by a first cooling plate comprising the first outer wall and the first boundary wall,
the second cooling region is provided by a second cooling plate comprising the second outer wall and the second boundary wall,
wherein the two cooling plates are joined together in their edge regions opposite one another with respect to the second direction.
